(19) United States
(12) Patent Application Publication
(10) Pub. No.: US 2006/0145801 A1
(43) Pub. Date: Jul. 6, 2006

(54) Inductive electro-communication component core from ferro-magnetic wire

(75) Inventor: Eliezer Adar, Sde Varburg (IL)

Correspondence Address: OBLON, SPIVAK, MCCLELLAND, MAIER & NEUSTADT, P.C., 1940 DUKE STREET, ALEXANDRIA, VA, 22314, US

(73) Assignee: AMT LTD, Even Yehuda (IL)

(21) Appl. No.: 11/024,791

(22) Filed: Dec. 30, 2004

(51) Int. Cl. H01F 17/06

(52) U.S. Cl. 336/175

(57) ABSTRACT

An inductive component includes a core and the core contains at least one winding of coated ferromagnetic wire, wound in a first direction. The coated ferromagnetic wire includes a dielectrically resistive coating, for example a glass coating, provided around a ferromagnetic center having a substantially round cross-section. The inductive component also includes a signal conductor wound around at least a part of the core in a second direction that is different than the first direction. In one embodiment, the dielectrically resistive coating is a glass coating provided around the ferromagnetic center in the coated ferromagnetic wire wound to form the core, and the signal conductor is wound perpendicular to the coated ferromagnetic wire windings in the core.

### BACKGROUND OF THE INVENTION

1. Field of the Invention

The present invention relates to the field of electronic and magnetic field components, and in particular to the field of inductive components. Specifically, the present invention relates to inductive components formed from glass-coated ferro-magnetic wire.

2. Discussion of the Background

Traditional inductive components include one or more signal conductors wound around a magnetic core. Conventional magnetic cores are typically formed from a plurality of magnetically conductive layers including flat plates or one or more ribbon tape windings. To reduce a flow of disadvantageous electrical eddy currents between the magnetically conductive layers or between ribbon winding layers, the magnetically conductive layers are individually laminated with an electrically insulating material or wound with electrically insulating tape.

For example, a background ribbon tape wound core 160 as shown in FIGS. 4, 5A, 5B, 6 and 7 is formed from metal tape ribbon 51 that has a rectangular cross-section shape that may be formed around a bobbin 52. In particular, FIG. 6 shows an example of the metal tape ribbon 51 being wound around the bobbin 52 to produce a background core 160, as shown in FIGS. 4, 5A and 5B. Further, a cross-sectional area of the metal tape ribbon is rectangular, as shown in FIG. 7.

### SUMMARY OF THE INVENTION

The present inventors recognized that such background tape winding components may result in several disadvantages now discussed.

First, the rectangular cross section of the metal tape ribbon does not closely match the shape of a true toroid, and therefore these cores do not adequately contain a resulting magnetic flux.

Further, during manufacture, metal tape ribbon wound cores are typically annealed to decrease tensile forces, to form oxide layers on the surface that support electrical isolation of the layers and to optimize magnetic properties of the core. However, the annealing process also makes the core more brittle and more sensitive to vibration and shock, weakens the insulating material, constrains the insulating materials that may be used, reduces reliability, and increases the overall cost of manufacture.

Metal tape ribbon wound cores may also have uneven internal and surface stress distributions. These uneven stress distributions may result in uneven surfaces with poor skin qualities, and may exhibit unpredictable magnetostriction. Further, metal tape ribbon wound cores may not easily be manufactured in a wide variety of geometrical configurations. Further, cores produced with metal tape ribbon result in a rectangular toroidal cross section, which does not efficiently contain a magnetic field.

Accordingly, one object of the present invention is to provide a novel inductive component to minimize or overcome the disadvantages in background inductive components described above, and to provide additional advantages.

An additional object of the present invention is to provide a novel method of manufacturing an inductive component. In particular, inductive components according to this invention may exhibit at least improved induction, magnetic loss, magnetic containment, magnetic leakage, magnetostriction, magnetic permeability characteristics, and EMI properties.

### BRIEF DESCRIPTION OF THE DRAWINGS

A more complete appreciation of the present invention and many of the attendant advantages thereof will be readily obtained as the same becomes better understood by reference to the following detailed description when considered in connection with the accompanying drawings, wherein:

FIG. 1 includes a perspective view of an inductive component according to an embodiment of the present invention;

FIGS. 2A and 2A(1) show side and end views of an inductive component core according to an embodiment of the present invention;

FIGS. 2B and 2B(2) show side and perspective views of the transformer core according to an embodiment of the present invention;

FIG. 2C shows a cut-away view of the transformer core section 2C-2C in FIG. 2B;

FIG. 3 shows a cross-section view of a ferromagnetic wire utilized in components, according to an embodiment of the present invention;

FIG. 4 shows a view of a background metal tape ribbon wound core;

FIGS. 5A and 5B show two views of a background metal tape ribbon wound core;

FIG. 6 shows a process of assembling an inductive component with a background metal ribbon wound core; and

FIG. 7 shows a cross-section view of a background metal ribbon tape used in a background inductive component.

### DESCRIPTION OF THE PREFERRED EMBODIMENTS

Referring now to the drawings, wherein like reference numerals designate identical or corresponding parts throughout the several views, and more particularly to FIG. 1 thereof, one embodiment of an inductive component according to the present invention is shown. The inductive component 1 in this embodiment includes at least one signal conductor 2, and a coated ferromagnetic wire core 3.

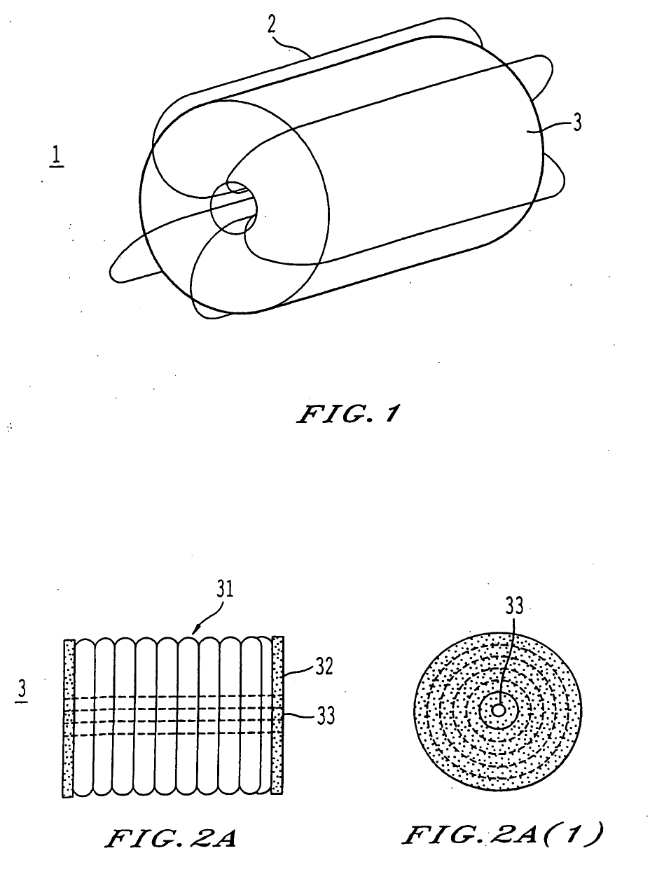

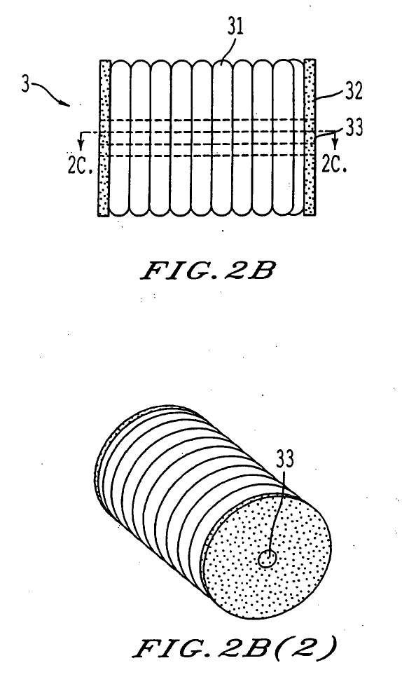

As further illustrated in the example of FIGS. 2A-2C, the coated ferromagnetic wire core 3 includes one or more strands of coated ferromagnetic wire 31, which are wound around a supporting surface 321 of a bobbin 32. A winding direction of the coated ferromagnetic wire 31 is substantially orthogonal to the winding direction of the signal conductor 2 and parallel to the direction of the magnetic field flux lines of the magnetic field produced by a current in the signal conductor 2. The bobbin 32 includes at least one hole 33 through which the signal conductor 2 is wound. An electrical current in the signal conductor 2 produces a magnetic field within, and around, the coated ferromagnetic wire core 3. Although the winding direction of the coated ferromagnetic wire 31 is substantially orthogonal to the winding direction of the signal conductor 2, other angular relationships between these winding directions may also be useful.

In this example, the bobbin 32 provides structural support for coated ferromagnetic wire windings as the wire core 3, and can be formed of any non-magnetic material including plastic or paper. However, alternative embodiments are possible in which the coated ferromagnetic wire is self-supporting and no bobbin is required.

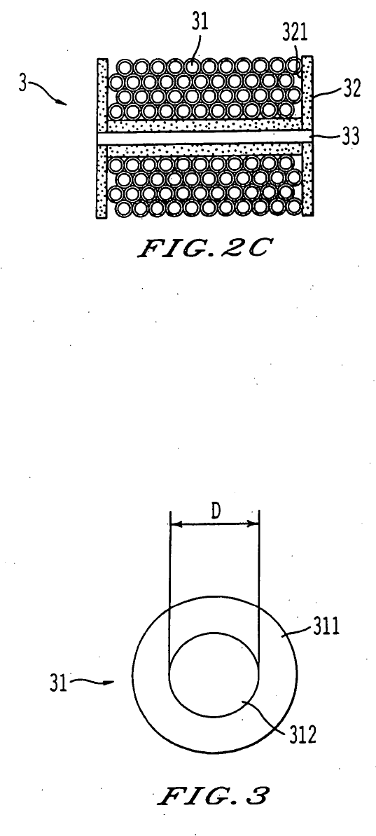

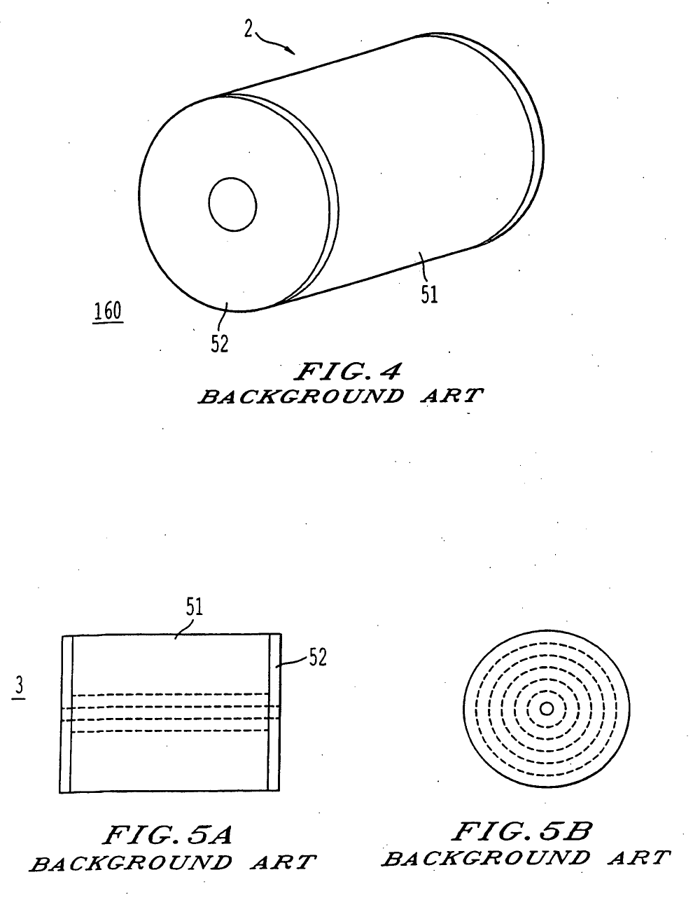

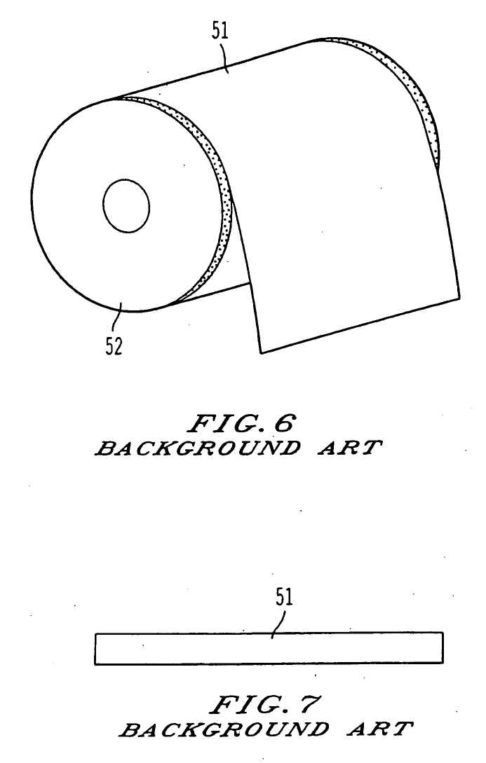

FIG. 3 illustrates an example of a cross-section of a coated ferromagnetic wire 31 as used in the present invention. The shape of the cross-section is substantially round. The coated ferromagnetic wire 31 includes a coating 311 that covers a ferromagnetic center 312. The ferromagnetic center may be formed of an amorphous metal, a nanocrystalline metal, a ferrite (i.e., oxide of nickel, iron, or manganese, for example), a nickel iron based permalloy, or other similar ferro-magnetic materials. The coating 311 may be formed of glass, polymer, or other dielectrically resistive or insulating materials. Further, the coating 311 may be formed as a single continuous material, or sections of material arranged as strips or foil layers.

Several advantages result from the use of a coated ferromagnetic wire to form magnetically conductive layers in the present inductive component core. The coating 311 covering the ferromagnetic center 312, as shown in the example of FIG. 3, provides a dielectrically resistive or insulating layer between subsequent conductive layers and between adjacent microwire turns thereby preventing the flow of electrical current between layers. Thus, additional coating layers or laminations to electrically insulate the core magnetically conductive layers from one another may be omitted, thereby reducing cost and complexity.

Another potential advantage is improved skin effects. The cross sectional area of the ferromagnetic wire 31 is substantially circular and the outer surface of the ferromagnetic wire 31 is smooth and homogenous, resulting in improved skin effects, and reduced magnetic field leakage.

Another advantage is a reduction in eddy current. Eddy currents are generated within conductors lying inside a magnetic field, in a direction perpendicular to the magnetic field flux lines. However, the coated ferromagnetic wire core according to the present embodiment includes ferromagnetic wires wound in the direction of the magnetic field flux. Thus, eddy currents may form only within individual wires in the cross-sectional plane, as shown in the example of FIG. 3. The cross-sectional dimension D of the ferromagnetic wire is significantly smaller than the width (i.e., longest dimension in the cross-sectional plane) of metal ribbon tape 51, thereby diminishing the eddy current that can flow in that direction. For example, the cross-sectional dimension D of the ferromagnetic wire may be on the order of a micron or a few microns in electronic component embodiments in which a reduced eddy current is more important than the stacking factor (i.e., ratio of magnetic conductive material to insulating material in the cross-sectional plane). Alternatively, the dimension D of the ferromagnetic wire in another embodiment of an electronic component may be on the order of a millimeter or a few millimeters when a high stacking factor is more important than a reduction of eddy current.

The ferromagnetic center of coated ferromagnetic wire may advantageously include an amorphous metal alloy, for example, a Co-based alloy, a Fe-based alloy, or a Ni based alloy.

Alternatively, the coated ferromagnetic wire may be a glass-coated metal microwire. Glass-coated metal microwires are suitable for use in severe environments including, for example, high temperatures, corrosive chemical or biological contaminants, high moisture, deep vacuum, and high pressure. Thus, an inductive component with a glass-coated metal microwire core according to the present invention is also suited to better withstand these environments.

In addition, annealing is not required for inductive component cores made from glass-coated metal microwires because glass-coated metal microwires do not exhibit uneven internal and surface stress distributions. The present inventors have further discovered that annealing does not substantially influence the characteristics of transformers produced according to the present invention, especially when the ferromagnetic center includes a Co-based amorphous metal alloy. In particular, over a signal frequency range of 50 Hz-100 kHz, transformer induction, squareness ratio (i.e., a ratio of core retentivity to core saturation flux (Br/Bmax) indicating core efficiency), magnetic field loss, coercivity, and magnetic permeability remain substantially unchanged after annealing an inductive component with a glass-coated metal microwire having a Co-based amorphous metal alloy metal center.

Further, a squareness ratio remains substantially unchanged after annealing an inductive component with a glass-coated metal microwire core having a Fe-based alloy metal center. Annealing causes an increase in induction, magnetic loss, and magnetic permeability in an inductive component with a glass-coated metal microwire core having a Fe-based alloy metal center.

In addition, a core made from glass-coated metal microwire may be easily formed in a wide variety of shapes and sizes.

Further, in each of the embodiments described above, a substantially toroidal inductive component shape was described; however, other inductive component shapes may also be advantageously achieved according to the present invention. For example, gapped toroids and multiple winding inductive components may also be formed according to the present invention.

Inductive components may be manufactured according to the present invention by first creating the core windings and then winding the signal conductor or signal conductors around the completed core winding.

Alternatively, the inductive component may also be manufactured by winding coated ferromagnetic wire around a bobbin until a desired core shape is achieved, and next winding the signal conductor or signal conductors around the core.

Alternatively, the inductive component may also be manufactured by winding coated ferromagnetic wire around a temporary bobbin until a desired core shape is achieved, removing the temporary bobbin, and then winding the signal conductor or signal conductors around the core.

Alternatively, the inductive component may also be manufactured by winding coated ferromagnetic wire around a bobbin, at the same time as winding the at least one signal conductor around coated ferromagnetic wire to form the core and the signal winding at the same time.

An annealing step may alternatively be performed to change some inductive component parameters, either after forming the desired core shape and before winding the signal conductor, or after winding the signal conductor.

Although inductive components such as transformers have been discussed above, it should be understood that the teachings herein also apply to other inductive components that utilize magnetic fields, as discussed above. For example, the teachings above also apply to electronic chokes, inductors, magnetic field sensors, Hall Effect devices, magnetometers, and other components that employ magnetic fields.

Obviously, numerous additional modifications and variations of the present invention are possible in light of the above teachings. It is therefore to be understood that within the scope of the appended claims, the present invention may be practiced otherwise than as specifically described herein.

1. An inductive component, comprising:
a core containing at least one winding of coated ferromagnetic wire in a first direction, said coated ferromagnetic wire including a dielectrically resistive coating around a ferromagnetic center, and a cross-section of the ferromagnetic center being substantially round; and
a signal conductor wound around at least a part of said core in a second direction different than the first direction.

2. The inductive component of claim 1, wherein the ferromagnetic center includes a magnetic metal.

3. The inductive component of claim 1, wherein the ferromagnetic center includes an amorphous metal.

4. The inductive component of claim 1, wherein the ferromagnetic center includes a nanocrystalline metal.

5. The inductive component of claim 1, wherein the ferromagnetic center includes a ferrite.

6. The inductive component of claim 1, wherein the ferromagnetic center includes a μ-metal.

7. The inductive component of claim 1, wherein the core further comprises a bobbin, and wherein the coated ferromagnetic wire is wound around the bobbin in the first direction.

8. The inductive component of claim 7, wherein the first direction is perpendicular to the second direction.

9. The inductive component of claim 1, wherein the coated ferromagnetic wire includes a glass-coated metal microwire.

10. The inductive component of claim 1, wherein the dielectrically resistive coating includes glass.

11. A method of making an electronic inductive component, comprising:
winding a coated ferromagnetic wire in a first direction to form a coated ferromagnetic wire core, said coated ferromagnetic wire including a dielectrically resistive coating around a ferromagnetic center, and a cross-section of the ferromagnetic center being substantially round; and
winding at least one signal conductor around at least a part of the coated ferromagnetic wire core in a second direction different than the first direction.

12. The method of claim 11, wherein winding a coated ferromagnetic wire includes winding at least one coated ferromagnetic wire around a bobbin.

13. The method of claim 12, further comprising removing the bobbin after winding the at least one coated ferromagnetic wire around the bobbin.

14. The method of claim 11, wherein the first direction is perpendicular to the second direction.
